(19) United States
(12) Patent Application Publication
(10) Pub. No.: US 2015/0352574 A1
(43) Pub. Date: Dec. 10, 2015

(54) MULTI-CHAMBER CONTAINER

(71) Applicant: COLGATE-PALMOLIVE COMPANY, New York, NY (US)

(72) Inventor: Matthew Lee Kolb, Milford, NJ (US)

(21) Appl. No.: 14/442,689

(22) PCT Filed: Nov. 19, 2012
(86) PCT No.: PCT/US2012/065745

§ 371 Date: May 13, 2015

(51) Int. Cl. B05B 11/00; A47K 5/00; B65D 81/32; B65D 51/24; B65D 25/04

(52) U.S. Cl. CPC B05B 11/3084; B65D 51/24; B65D 25/04; B65D 81/325; A47K 5/00; B05B 11/3014

(57) ABSTRACT

Provided is a multi-chamber dispenser for dispensing flowable substances, comprising: a body (100) having: a first storage chamber (113) for storing a first flowable substance, a second storage chamber (123) for storing a second flowable substance, a first outlet zone (141), a second outlet zone (142), a first inlet (150) that fluidly connects the first storage chamber (113) with the first outlet zone (141), a second inlet (160) that fluidly connects the second storage chamber (123) with the second outlet zone (142), a first apparatus (154) configured, on operation thereof, to dispense from the first storage chamber (113) via the first inlet (150) into the first outlet zone (141) a first predetermined volume of the first flowable substance, a second apparatus (164) configured, on operation thereof, to dispense from the second storage chamber (123) via the second inlet (160) into the second outlet zone (142) a second predetermined volume of the second flowable substance, and a lever (170) connected to the first and second apparatuses (154, 164) and rotatable relative to the first and second apparatuses (154, 164) between a first position and a second position, wherein rotation of the lever (170) from the first position to the second position causes operation of the first and second apparatuses (154, 164).

### FIELD OF THE INVENTION

The present invention relates to a multi-chamber container. The multiple chambers of the container may store respective flowable substances, for example, respective oral care products such as mouthwashes or respective components of a mouthwash.

### BACKGROUND OF THE INVENTION

A multi-chamber container is a container having more than one chamber for storing respective substances out of contact with one another. It may be desirable to keep the respective substances out of contact with one another during storage of the respective substances, for example if the substances might react or deteriorate over time should they be allow to mix.

Over the years, efforts have been made to improve the design of multi-chamber containers to try to prevent, during dispensing of two substances from respective chambers of the container, a first of the substances from a first of the chambers flowing into a second of the chambers hold mg a second of the substances causing inadvertent mixing of the substances. For example, it is known to provide a two-compartment container with two discharge openings, each leading to a respective one of the compartments, and rib members between the discharge openings to hinder a substance from the first compartment flowing into the second compartment during dispensing of the substances.

However, when using such a known container, a user may tilt the container in such a way that one of the substances flows over or around the rib members so that the substances become mixed on or in the container during a dispensing routine. Therefore, despite these efforts, a need still exists for multi-chamber container with a structure that better prevents, during dispensing of two substances from respective chambers of the container, a first of the substances stored in a first of the chambers flowing into a second of the chambers storing a second of the substances.

### SUMMARY OF THE INVENTION

A first aspect of the present invention provides a multi-chamber container for dispensing flowable substances, comprising: a body having: a first storage chamber for storing a first flowable substance, a second storage chamber for storing a second flowable substance, a first outlet zone, a second outlet zone, a first inlet that fluidly connects the first storage chamber with the first outlet zone, a second inlet that fluidly connects the second storage chamber with the second outlet zone, a first apparatus configured, on operation thereof, to dispense from the first storage chamber via the first inlet into the first outlet zone a first predetermined volume of the first flowable substance, a second apparatus configured, on operation thereof, to dispense from the second storage chamber via the second inlet into the second outlet zone a second predetermined volume of the second flowable substance, and a lever connected to the first and second apparatuses and rotatable relative to the first and second apparatuses between a first position and a second position, wherein rotation of the lever from the first position to the second position causes operation of the first and second apparatuses.

Preferably, the body comprises a frame to which the lever is rotatably mounted. Preferably, the frame is immovable relative to the first and second storage chambers.

The first and second outlet zones may be defined by a vessel, wherein rotation of the lever relative to the frame from the first position to the second position causes movement of the vessel relative to the frame.

Preferably, the vessel is connected to the lever via a cam mechanism. Optionally, the cam mechanism comprises a projection of one of the vessel and the lever and a track of the other of the vessel and the lever, wherein the projection is disposed in or on the track so that rotation of the lever relative to the frame causes the projection to follow the track. Optionally, the lever comprises the track and the vessel comprises the projection.

Preferably, rotation of the lever relative to the frame from the first position to the second position causes linear movement of the vessel relative to the frame.

Optionally, the frame at least partially surrounds the vessel.

The frame may include one or more features that cooperate with one or more features of the vessel to guide the movement of the vessel relative to the frame.

Preferably, the first and second apparatuses comprise respective pumps, such as respective piston pumps. The first apparatus may comprise a first piston movably disposed in a first cylinder and the second apparatus may comprise a second piston movably disposed in a second cylinder. Preferably, the first and second cylinders are immovable relative to the frame, and rotation of the lever from the first position to the second position causes the first and second pistons to move in the respective first and second cylinders. The first and second pistons may be immovable relative to the first and second outlet zones and/or relative to the vessel.

Optionally, the container comprises a first dip tube extending from the first cylinder to the first storage chamber and a second dip tube extending from the second cylinder to the second storage chamber.

Preferably, the container comprises a closure movable relative to the body between a closed position, at which the closure isolates the first and second outlet zones from an exterior of the container, and an open position, at which the first and second outlet zones are in fluid communication with the exterior of the container.

Preferably, when the closure is at the closed position, the closure is spaced from the first and second inlets.

Optionally, when the closure is at the open position, the closure is detached from the body.

Optionally, the closure has a first cavity, a second cavity, and a divider isolating the first cavity from the second cavity and, when the closure is at the closed position, the first cavity is in fluid communication with the first outlet zone and the second cavity is in fluid communication with the second outlet zone.

Optionally, the container comprises a lock for locking the closure at the closed position.

The first and second storage chambers may be defined by respective non-unitary first and second vessels. The first and second outlet zones may be defined by a third vessel that is non-unitary with the first and second vessels and is connected to the first and second vessels. Preferably, the body has an end face and the first and second vessels are disposed in parallel between the third vessel and the end face.

Optionally, the body comprises a separator that isolates the first outlet zone from the second outlet zone.

Optionally, the first outlet zone is a first portion of a mixing chamber of the body and the second outlet zone is a second portion of the mixing chamber. Further optionally, the container comprises a closure movable relative to the body between a closed position, at which the closure isolates the first and second outlet zones from an exterior of the container, and an open position, at which the first and second outlet zones are in fluid communication with the exterior of the container, wherein the closure has a divider and, when the closure is at the closed position, the divider is disposed in the mixing chamber and isolates the first portion of the mixing chamber from the second portion of the mixing chamber and, when the closure is at the open position, the first portion of the mixing chamber is in fluid communication with the second portion of the mixing chamber. Preferably, when the closure is at the open position, the mixing chamber is free of the divider.

Preferably, the first outlet zone has a first volume equal to or greater than the first predetermined volume, and the second outlet zone has a second volume equal to or greater than the second predetermined volume. Optionally, the first predetermined volume is equal to the second predetermined volume.

Preferably, the lever has a first end portion rotatably mounted to a first portion of the frame and a second end portion rotatable mounted to a second portion of the frame. Preferably, the first and second apparatuses are disposed between the first and second end portions of the lever.

Optionally, the container is elongate with a longitudinal axis, and wherein the lever is rotatable about an axis that is perpendicular to the longitudinal axis. The longitudinal axis may extend between a first end of the container and a planar end face of the container.

Preferably, the first and second inlets comprise respective check valves that allow respective flows of the respective flowable substances in a direction from the respective first and second storage chambers towards the respective first and second outlet zones and that prevent flow of respective first and second flowable substances in the respective opposite directions.

### BRIEF DESCRIPTION OF THE DRAWINGS

FIG. 1 is an exploded view of components of a multi-chamber container according to a first embodiment of the present invention;

FIG. 2 is a perspective view showing the components of FIG. 1 assembled to form the multi-chamber container according to the first embodiment of the present invention, shown with the lever of the container at its first position relative to the first and second apparatuses of the container and with the closure at its closed position;

FIG. 3 is a perspective view of the multi-chamber container of FIG. 2, shown with the lever of the container at its second position relative to the first and second apparatuses of the container and with the closure detached from the body at its open position; and

FIG. 4 is a cross sectional view of the multi-chamber container of FIG. 3, shown with the lever of the container at its second position relative to the first and second apparatuses of the container and with the closure detached from the body at its open position.

### DETAILED DESCRIPTION OF THE PREFERRED EMBODIMENTS

The following description of the preferred embodiments is merely exemplary in nature and is in no way intended to limit the invention, its application, or uses. The description of illustrative embodiments according to principles of the present invention is intended to be read in connection with the accompanying drawings, which are to be considered part of the entire written description. In the description of embodiments of the invention disclosed herein, any reference to direction or orientation is merely intended for convenience of description and is not intended in any way to limit the scope of the present invention. Relative terms such as “lower,” “upper,” “horizontal,” “vertical,” “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation unless explicitly indicated as such. Terms such as “attached,” “affixed,” “connected,” “coupled,” “interconnected,” and similar refer to a relationship wherein structures are secured or attached to one another either directly or indirectly through intervening structures, as well as both movable or rigid attachments or relationships, unless expressly described otherwise. Moreover, the features and benefits of the invention are illustrated by reference to the preferred embodiments. Accordingly, the invention expressly should not be limited to such preferred embodiments illustrating some possible non-limiting combination of features that may exist alone or in other combinations of features.

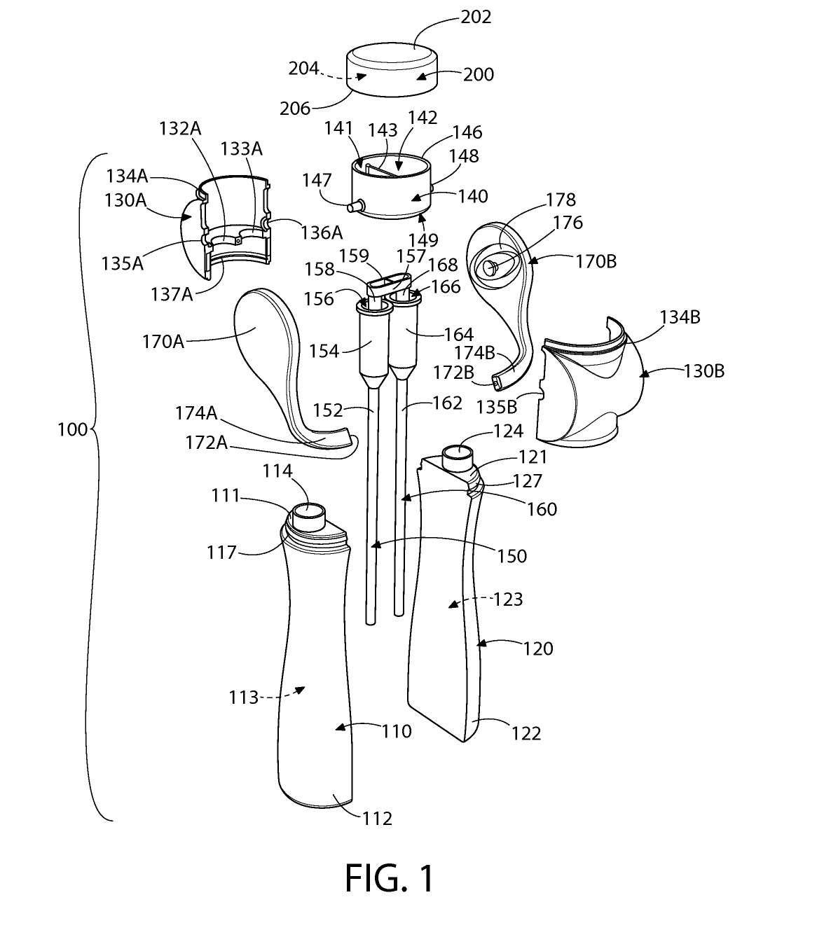

A multi-chamber container for dispensing flowable substances and according to a first embodiment of the present invention will be described with reference to FIGS. 1 to 4.

The container 1 of the first embodiment comprises a body 100 and a closure 200. The body 100 comprises first and second storage chambers 113, 123 each for storing a flowable substance, or each storing a flowable substance, such as a liquid or a paste. The storage chambers 113, 123 keep the flowable substances separate from each other. The flowable substances may each be an oral care product, such as a mouthwash. Alternatively, the flowable substances may be two parts of an oral care product, such as a mouthwash, that is created when the flowable substances are mixed.

The first and second storage chambers 113, 123 are defined by respective first and second vessels 110, 120 of the body 100, which first and second vessels 110, 120 have respective orifices 114, 124 at a first small end 111, 121 thereof. Each of the first and second vessels 110, 120 has a second small end 112, 122 at an end opposite to the first small end 111, 121 thereof. Together, the second small ends 112, 122 form a first longitudinal end 125 of the container 1. The first longitudinal end 125 of the container 1 has a planar end face 126, upon which the container 1 may stand on a surface when stored or operated to dispense the first and second flowable substances.

Each of the first and second vessels 110, 120 is elongate between its first and second small ends 111, 112, 121, 122. The first and second vessels 110, 120 are made from a hard, preferably rigid, material. However, in a variation to this embodiment, the first and second vessels 110, 120 are made from a flexible, preferably resilient, material. The first and second vessels 110, 120 are non-unitary. That is, the first and second vessels 110, 120 are not integrally formed together, but instead are separate components that are connected together during assembly of the container 1. In a variation to the illustrated embodiment, the first and second storage chambers 113, 123 may be respective chambers in a single, unitary vessel. Such a single, unitary vessel may be made from a hard, preferably rigid, material, or from a flexible, preferably resilient, material.

The body 100 of the container 1 further comprises a third vessel 140 that is non-unitary with the first and second vessels 110, 120. The third vessel 140 is connected to the first and second vessels 110, 120 during assembly of the container 1. The third vessel 140 is connected to the first and second vessels 110, 120 via a lever 170 and a frame 130, each of which is described in more detail below. The third vessel 140 defines a first outlet zone 141, a second outlet zone 142, and a separator 143 that separates the first outlet zone 141 from the second outlet zone 142. In a variation to this embodiment, the separator 143 is omitted so that the first outlet zone 141. is in fluid communication with the second outlet zone 142 within the third vessel 140. In such a variation, the first outlet zone 141 is a first portion of a mixing chamber of the body 100 and the second outlet zone 142 is a second portion of the mixing chamber.

The body 100 of the container 1 further comprises first and second inlets 150, 160 that respectively fluidly connect the first and second storage chambers 113, 123 with the first and second outlet zones 141, 142. In this embodiment, the first inlet 150 comprises a first dip tube 152 extending between the first storage chamber 113 and a first cylinder 154, the first cylinder 154, a first hollow piston 158 movably disposed in the interior 156 of the first cylinder 154, and a first channel through a connection member 157 fixed to one end of the first hollow piston 158, which first channel fluidly connects an interior of the first hollow piston 158 to a first opening 144 into the first outlet zone 141. Similarly, the second inlet 160 comprises a second dip tube 162 extending between the second storage chamber 123 and a second cylinder 164, the second cylinder 164, a second hollow piston 168 movably disposed in the interior 166 of the second cylinder 164, and a second channel through the connection member 157 fixed to one end of the second hollow piston 168, which second channel fluidly connects an interior of the second hollow piston 168 to a second opening 145 into the second outlet zone 142. A face 159 of the connection member 157 is fixed to an underside 149 of the third vessel 140, whereby the first and second pistons 158, 168 are immovable relative to the third vessel 140. The dip tubes 152, 162 are immovable relative to the first and second cylinders 154, 164, and the first and second cylinders 154, 164 are fixed to the first and second vessels 110, 120, such as by adherence, press-fit or other manner into the respective orifices 114, 124.

The first hollow piston 158 has a first piston head (not shown) movably disposed in the interior 156 of the first cylinder 154. A seal is provided between the first piston head and the wall of the first cylinder 154 that defines the interior 156 of the first cylinder 154, so that any fluid passing through the first cylinder 154 must only pass through the interior of the first hollow piston 158. The first hollow piston 158 includes a first check valve (not shown) at the interior of the first hollow piston 158, which allows flow of the first flowable substance in a direction from the first storage chamber 113 towards the first outlet zone 141 and prevents flow of the first flowable substance in the opposite direction. Correspondingly, the second hollow piston 168 has a second piston head (not shown) movably disposed in the interior 166 of the second cylinder 164. A seal is provided between the second piston head and the wall of the second cylinder 164 that defines the interior 166 of the second cylinder 164, so that any fluid passing through the second cylinder 164 must only pass through the interior of the second hollow piston 168. The second hollow piston 168 includes a second check valve (not shown) at the interior of the second hollow piston 168, which allows flow of the second flowable substance in a direction from the second storage chamber 123 towards the second outlet zone 142 and prevents flow of the second flowable substance in the opposite direction.

As will be described in more detail below, the body 100 comprises a first apparatus configured, on operation thereof, to dispense from the first storage chamber 113 via the first inlet 150 into the first outlet zone 141 a first predetermined volume of the first flowable substance, and a second apparatus configured, on operation thereof, to dispense from the second storage chamber 123 via the second inlet 160 in to the second outlet zone 142 a second predetermined volume of the second flowable substance. The first apparatus comprises a first piston pump comprising the first piston 158 and the first cylinder 154, while the second apparatus comprises a second piston pump comprising the second piston 168 and the second cylinder 164.

The body 100 further comprises the frame 130 substantially in the form of a collar that is non-unitary with the first and second vessels 110, 120. In some embodiments, the frame 130 may be unitary with the body 100, and/or the first and second vessels 110, 120. The frame 130 is assembled from two individual frame parts 130A, 130B that are connected to each other and to the first and second vessels 110, 120 during assembly of the container 1. The frame 130 is fixed to both the first small ends 111, 121 of the first and second vessels 110, 120, so as to be immovable relative to the first and second storage chambers 113, 123. More specifically, an annular ridge 137 of the frame 130, which ridge is formed from two semi-annular ridge parts 137A, 137B of the respective frame parts 130A, 130B, mates with a pair of semi-annular grooves 117, 127 disposed at the respective first small ends 111, 121 of the first and second vessels 110, 120. Together, the semi-annular grooves 117, 127 form an annular groove with which the annular ridge 137 of the frame 130 mates. The frame 130 has an annular wall and an internal radially extending platform extending between opposite sides of the annular wall. The platform has two circular through-holes 132, 133 formed therein, each of which is formed from respective semi-circular holes 132A, 132B, 133A, 133B in respective platform parts comprised in the respective frame parts 130A, 130B, The first and second cylinders 154, 164 are fixedly located in the respective through-holes 132, 133. The first and second cylinders 154, 164 may be adhered to the respective through-holes 132, 133. In any event, the first and second cylinders 154, 164 are immovable relative to the frame 130.

The body 100 further comprises the lever 170 rotatably connected to the frame 130. The lever 170 is assembled from two individual lever parts 170A, 170B that are connected to each other during assembly of the container 1. The individual lever parts 170A, 170B are joined to each other at respective end faces 172A, 172B thereof. The lever 170 has a first end portion 175 rotatably mounted to a first portion 135 of the frame 130 and a second end portion 176 rotatable mounted to a second portion 136 of the frame 130. The first and second apparatuses mentioned above are disposed between the first and second end portions 175, 176 of the lever 170.

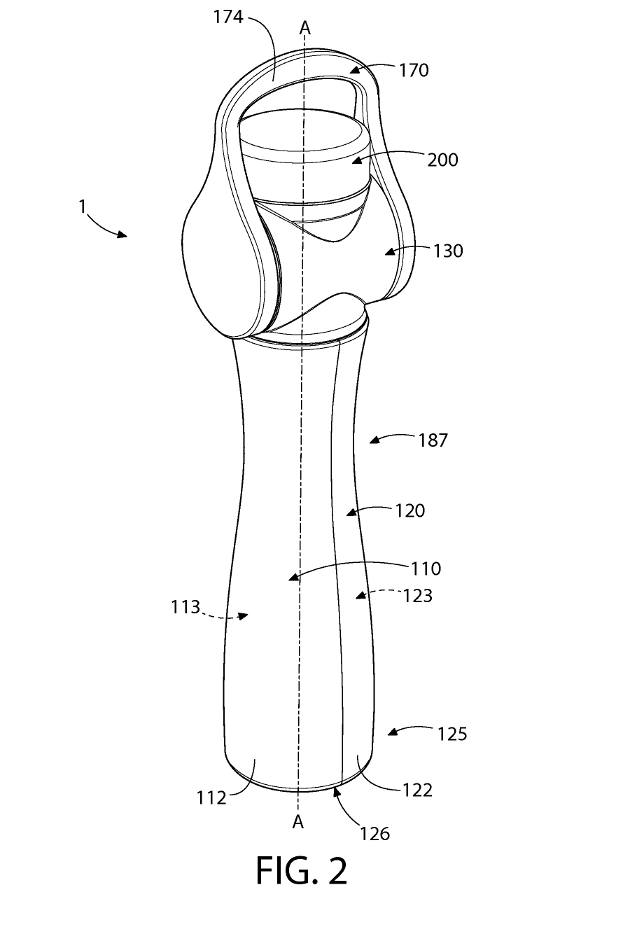

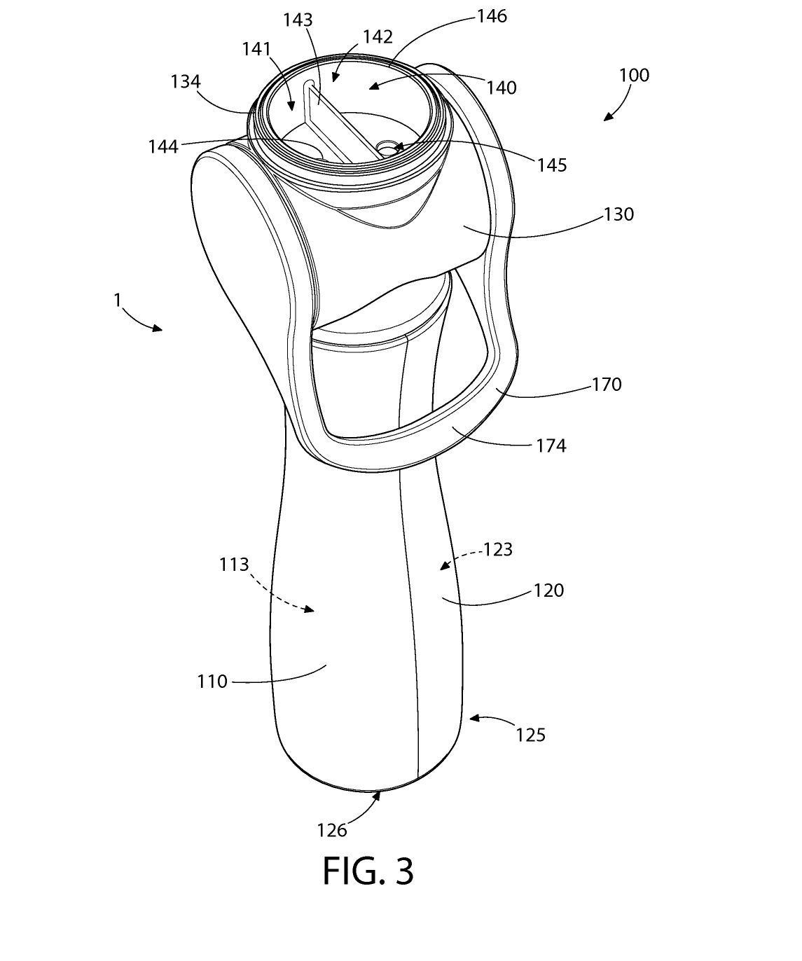

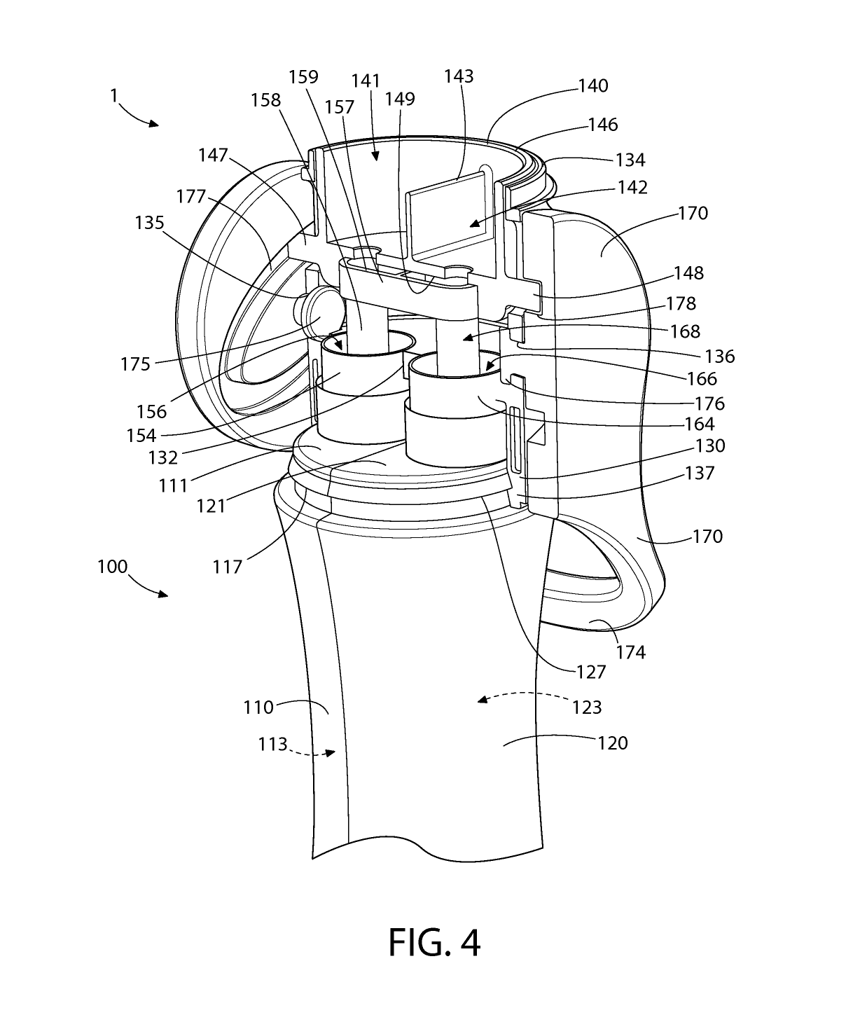

More specifically, the frame 130 includes a first circular aperture 135 formed though the annular wall and a second circular aperture 136 formed though the annular wall at a position diametrically opposed to the first circular aperture 135. Each of the first and second apertures 135, 136 is formed from respective semi-circular holes 135A, 135B, 136A, 136B in respective halves of the annular wall comprised in the respective frame parts 130A, 130B. The lever 170 has a first peg 175 extending from a first 170A of the lever parts and disposed in the first circular aperture 135, and a second peg 176 extending from a second 170B of the lever parts and disposed in the second circular aperture 136. The first and second pegs 175, 176 protrude towards each other from opposite interior sides of the lever 170. In a variation to this embodiment, the lever 170 comprises a pair of apertures that receive diametrically-opposed pegs provided to the frame 130. In any event, rotation of the pegs 175, 176 in the respective apertures 135, 136 is permitted, so that the lever 170 is rotatable relative to the first and second apparatuses between a first position (see FIG. 2) and a second position (see FIGS. 3 and 4).

As will be described in more detail below, rotation of the lever 170 from the first position to the second position causes operation of the first and second apparatuses to dispense the respective first and second predetermined volumes of the first and second flowable substances to the respective first and second outlet zones 141, 142. It is to be noted that the first outlet zone 141 has a first volume equal to, or greater than, the first predetermined volume, and the second outlet zone 142 has a second volume equal to or greater than, the second predetermined volume. Moreover, in this embodiment, the first predetermined volume is equal to the second predetermined volume.

The lever 170 further comprises a handle 174 that is grippable by a user. The handle 174 is formed from respective handle parts 174A, 174B of the respective lever parts 170A, 170B, which are joined to each other at the respective end faces 172A, 172B. The lever 170 further includes first and second elliptical tracks 177, 178 that face each other from opposite lateral sides of the body 100. The first and second elliptical tracks 177, 178 are disposed concentrically with the respective first and second pegs 175, 176, and will be described in more detail below.

The third vessel 140 is connected to the lever 170 via a cam mechanism, whereby rotation of the lever 170 relative to the frame 130 between the first and second positions causes linear movement of the third vessel 140 relative to the frame 130. Moreover, since the first and second pistons 158, 168 are immovable relative to the third vessel 140, rotation of the lever 170 relative to the frame 130 between the first and second positions causes the first and second pistons 158, 168 to move in the respective first and second cylinders 154, 164. The cam mechanism comprises first and second projections 147, 148 projecting radially outwards from opposing sides of the third vessel 140, which first and second projections 147, 148 are disposed in the respective first and second elliptical tracks 177, 178 comprised in the lever 170, so that rotation of the lever 170 relative to the frame 130 causes the first and second projections 147, 148 to follow the respective first and second elliptical tracks 177, 178.

The frame 130 surrounds the third vessel 140. Moreover, the third vessel 140 has an exterior that is shaped and sized to correspond closely to an interior of the frame 130, whereby the frame 130 includes has a feature that cooperates with a feature of the third vessel 140 to guide the movement of the third vessel 140 relative to the frame 130. In a variation to the illustrated embodiment, one of the third vessel 140 and the frame 130 may have a protrusion and the other of the third vessel 140 and the frame 130 may have a linear channel extending parallel to a longitudinal axis A-A of the container 1, within which channel the protrusion is located to restrict the third vessel 140 to linear movement relative to the frame 130.

As mentioned above, the container 1 also comprises a closure 200. The closure 200 is a cup that is movable relative to the body 100 between a closed position, at which the closure 200 isolates the first and second outlet zones 141, 142 from an exterior of the container 1, and an open position, at which the first and second outlet zones 141, 142 are in fluid communication with the exterior of the container 1. When the closure 200 is at the open position, the closure 200 is detached from the body 100. However, when the closure 200 is at the closed position, the closure 200 is mounted on the frame 130 with a rim 206 of the closure 200 mating with an edge 134 of the third vessel 140, which edge 134 is formed from two semi-annular edge parts 134A, 134B of the respective frame parts 130A, 130B. When mounted on the frame 130 at the closed position, the closure 200 is spaced from the first and second openings 144, 145. The closure 200 includes a planar face 202, upon which the container 1 may stand on a surface.

In this embodiment, the closure 200 comprises a mixing chamber 204 and, when the closure 200 is at the closed position, the first and second outlet zones 141, 142 are in fluid communication with the mixing chamber 204 of the closure 200 so that any substances flowing through the first and second outlet zones 141, 142 into the mixing chamber 204, if the container 1 is inverted, are permitted to mix in the mixing chamber 204.

In a variation to this embodiment, the closure 200 comprises a first cavity, a second cavity, and a divider isolating the first cavity from the second cavity and, when the closure is at the closed position, the first outlet zone 141 is in fluid communication with the first cavity of the closure, the second outlet zone 142 is in fluid communication with the second cavity of the closure and the divider of the closure creates a seal with the separator 143 of the third vessel 140 to isolate the first and second outlet zones 141, 142 from each other. Accordingly, in such a variation, the divider prevents mixing in the closure 200 of any substances flowing from the first and second outlet zones 141, 142 into the first and second cavities of the closure 200, if the container is inverted.

In the described variation in which the separator 143 is omitted, so that the first outlet zone 141 is in fluid communication with the second outlet zone 142 and the first and second outlet zones 141, 142 are respective first and second portions of a mixing chamber of the body 100, the closure 200 may comprise a divider which, when the closure 200 is at the dosed position, is disposed in the mixing chamber and isolates the first portion of the mixing chamber from the second portion of the mixing chamber and which, when the closure 200 is at the open position, places the first portion of the mixing chamber in fluid communication with the second portion of the mixing chamber. Accordingly, in such a variation, the divider prevents mixing in the mixing chamber of the first and second flowable substances, even if the container is inverted, when the closure 200 is at the closed position, but permits such mixing in the mixing chamber When the closure 200 is at the open position. Optionally, the closure 200 would have a first cavity, a second cavity, and the divider would isolate the first cavity from the second cavity. In such a case, when the closure is at the closed position, the first outlet zone 141 is in fluid communication with the first cavity of the closure 200 and the second outlet zone 142 is in fluid communication with the second cavity of the closure 200. Preferably, when the closure 200 is at the open position, the mixing chamber is free of the divider. Accordingly, in such a variation, the divider prevents mixing in the mixing chamber of the first and second flowable substances when the closure 200 is at the closed position. When the container is inverted and the closure 200 is then placed at its open position, the divider prevents mixing in the closure 200 of the first and second flowable substances.

During assembly of the multi-chamber container 1, (a) the first and second dip tubes 152, 162 are inserted into the respective first and second storage chambers 113, 123, (b) the first and second cylinders 134, 164 connected to the respective first and second dip tubes 152, 162 are disposed in the respective first and second orifices 114, 124, (c) the first and second pistons 158, 168 are inserted into the interiors 156, 166 of the respective first and second cylinders 154, 164 with the connection member 157 connecting the first and second pistons 158, 168, (d) the underside 149 of the third vessel 140 is fixed to the face 159 of the connection member 157, (e) the two lever parts 170A, 170B are connected together to form the lever 170 while locating the projections 147, 148 of the third vessel 140 in the respective first and second elliptical tracks 177, 178, and (f) the two frame parts 130A, 130B are connected together to form the frame 130 while locating the pegs 175, 176 of the lever 170 in the respective first and second apertures 135, 136 and while mating the semi-annular ridge parts 137A, 137B of the respective frame parts 130A, 130B with the pair of semi-annular grooves 117, 127 to connect the first and second vessels 110, 120 together and to the frame 130. The respective first small ends 111, 121 of the first and second vessels 110, 120 may be fixed to the frame 130 using adhesive or by sonic welding the frame 130 to the first and second vessels 110, 120.

Steps (a) to (f) may be carried out in the recited order. Alternatively, the order of the steps may be changed, and/or some of the steps may be carried out simultaneously.

Finally, the closure 200 is connected to the third vessel 140 by mating the rim 206 of the closure 200 with the edge 134 of the third vessel 140. The container 1 may comprise a lock (not shown) for locking the closure 200 to the body 100 at its closed position.

Accordingly, in the assembled container 1, the first and second storage chambers 113, 123 are disposed in parallel between the planar end face 126 and each of the frame 130, the third vessel 140 and the closure 200.

In the variation in which the first and second storage chambers 113, 123 are respective chambers in a single, unitary vessel, each of the frame 130 and the third vessel 140 may be non-unitary with the single, unitary vessel, and may be connected to the single, unitary vessel during assembly of the container 1.

Overall, the container 1 is elongate with the longitudinal axis A-A that extends through the planar end face 126 and through each of the frame 130, the third vessel 140, and the closure 200. The end 125 and the closure 200 are disposed at, and define, respective first and second longitudinal ends of the container 1, when the closure 200 is at the closed position. In this embodiment, the longitudinal axis A-A is orthogonal to the end face 126. Also, when the lever 170 is at the first position, the longitudinal axis A-A passes though the lever 170, as shown in FIG. 2. Moreover, the lever 170 is rotatable about an axis that is perpendicular to the longitudinal axis A-A. Further, the body 100 has an hourglass shape, which enables a user to take a firm hold of the container 1 during transport and use. In this embodiment, the hourglass shape is achieved by the first and second vessels 110, 120 together defining a waist 187 of the body 100 of the container 1, which waist 187 has a smaller lateral cross sectional area than each of the end 125 and the frame 130.

When a user wishes to dispense first and second predetermined volumes of the respective first and second flowable substances from the container 1, they first ensure that the container 1 is disposed with the first and second storage chambers 113, 123 below the third vessel 140. For example, the container 1 may be placed with its planar end face 126 on a surface. Preferably, but not essentially, the closure 200 is disposed at its closed position on the third vessel 140. The lever 170 should be disposed at its first position relative to the first and second apparatuses, i.e. relative to the pistons 158, 168 and cylinders 154, 164, so that the longitudinal axis A-A passes through the lever 170. When the lever 170 is at its first position, the third vessel 140 is disposed at a primary position relative to the frame 130.

The user then rotates the lever 170 from the first position shown in FIG. 2 to the second position shown in FIGS. 3 and 4. During this movement, due to the interaction between the protections 147, 148 and the elliptical tracks 177, 178, and due to the corresponding shapes of the exterior of the third vessel 140 and the interior of the frame 130, the third vessel 140 first undergoes linear movement from its primary position in a direction away from the frame 130 to a secondary position, and then undergoes linear movement back from its secondary position in a direction towards the frame 130 towards its primary position. In some embodiments, the lever 170 may be used to perform a full pump by rotating from one side of the body 100 (such as show in FIG. 2) to an opposing side of the body 100. In other embodiments, the lever 170 may be used to perform a full pump by rotating from one side of the body 100 (such as show in FIG. 2) to an opposing side of the body 100 and then back to the one side of the body 100 (such as shown in FIG. 2).

During movement of the third vessel 140 in the direction away from the frame 130, the pistons 158, 168 are moved in the first and second cylinders 154, 164 in a direction away from the first and second storage chambers 113, 123 with the first and second check valves closed. Accordingly, pressure on the side of the check valves facing the first and second storage chambers 113, 123 is reduced, and the first and second flowable substances are drawn up the respective first and second dip tubes 152, 162 from the respective first and second storage chambers 113, 123. During the subsequent movement of the third vessel 140 in the direction towards from the frame 130, the pistons 158, 168 are moved in the first and second cylinders 154, 164 in a direction towards the first and second storage chambers 113, 123, and the first and second check valves permit respective predetermined volumes of the first and second flowable substances to pass through the interiors of the respective first and second hollow pistons 158, 168 and towards the first and second outlet zones 141, 142 via the first and second openings 144, 145. The predetermined volumes of the first and second flowable substances are dependent on the stroke length of the pistons 158, 168 relative to the cylinders 154, 164 and on the cross sectional areas of the check valves when open.

The provision of the cam mechanism permits elimination of springs to bias the third vessel 140 to a particular position relative to the frame 130 and relative to the first and second storage chambers 113, 123. In addition to saving costs and permitting simplified assembly of the container 1, this also provides the user with precise control of the position of the third vessel 140. In turn, this provides the user with precise control of the volumes of the first and second flowable substances delivered to the first and second outlet zones 141, 142. The user is able to develop a memory of a particular lever 170 position, relative to the first and second storage chambers 113, 123 and relative to the first and second apparatuses, corresponding to their desired volumes of the first and second flowable substances delivered to the first and second outlet zones 141, 142.

Since the first and second apparatuses are disposed between the first and second end portions 175, 176 of the lever 170, during rotation of the lever 170, equal and balanced forces are applied to the pistons 158, 168, the pistons 158, 168 are moved over equal distances relative to the cylinders 154, 164, and equal predetermined volumes of the first and second flowable substances are dispensed.

When the lever 170 stops at its second position, movement of the check valves relative to the first and second flowable ceases, so the first and second flowable substances cease passing through the check valves.

Movement of the lever 170 from its second position back to its first position substantially repeats this process to eject more of the first and second flowable substances towards the respective first and second outlet zones 141, 142.

Since the first and second outlet zones 141, 142 have respective volumes equal to, or greater than, the respective predetermined volumes of the first and second. flowable substances, the respective predetermined volumes of the first and second flowable substances are held separately from each other in the first and second outlet zones 141, 142.

The user then carefully moves the closure 200 to its open position (if it is not already at its open position), brings a rim 146 of the third vessel 140 to their lips, and then pours the separate predetermined volumes of the first and second flowable substances into their mouth. Alternatively, the user may choose to pour the separate predetermined volumes of the first and second flowable substances into the mixing chamber 204 of the closure 200, to permit the predetermined volumes of the first and second flowable substances to mix therein. The user then brings the rim 206 of the closure 200 to their lips, and then pours the mixed predetermined volumes of the first and second flowable substances into their mouth.

Since the first and second flowable substances are kept isolated from each other in the body 100, mixing of the first and second flowable substances in the body 100 is prevented and contamination of the first inlet 150, first storage chamber 113 and first outlet zone 141 with the second flowable substance is avoided. Similarly, contamination of the second inlet 160, second storage chamber 123 and second outlet zone 142 with the first flowable substance is avoided.

In the illustrated embodiment, rotation of the lever 170 from the first (upright) position shown in FIG. 2 to the second position shown in FIGS. 3 and 4 causes the third vessel 140 to first undergo movement from its primary position in a direction away from the frame 130 to its secondary position, and to then undergo movement back from its secondary position in a direction towards the frame 130 towards its primary position. Movement of the third vessel 140 from its primary position to its secondary position and hack to its primary position can be considered one full pumping cycle. In variations to the illustrated embodiment, the paths of the tracks 177, 178 may be different to those shown in the Figures, such that rotation of the lever 170 over a different range cause the performance of one full pumping cycle. For example, the paths of the tracks 177, 178 may be such that it is necessary to rotate the lever 170 over its maximum range, from the position shown in FIGS. 3 and 4 via the upright position shown in FIG. 2 to a position (not shown) on the opposite side of the first and second storage chambers 113, 123 that is effectively a mirror image of the position shown in FIGS. 3 and 4, in order to perform of one full pumping cycle. Alternatively, the paths of the tracks 177, 178 may be such that it is necessary to rotate the lever 170 over its maximum range, from the position shown in FIGS. 3 and 4 to the position (not shown) on the opposite side of the first and second storage chambers 113, 123 that is effectively a mirror image of the position shown in FIGS. 3 and 4, and then also back again to the position shown in FIGS. 3 and 4, in order to perform of one full pumping cycle.

In the variations to the described embodiment in which the closure 200 comprises a first cavity, a second cavity, and a divider isolating the first cavity from the second cavity, mixing of the first and second flowable substances in the whole container 1 is preventable. After providing the respective predetermined volumes of the first and second flowable substances in the first and second outlet zones 141, 142, the user can maintain the closure 200 at its dosed position and invert the container 1 to cause the respective predetermined volumes of the first and second flowable substances to flow into the respective first and second cavities in the closure 200. The user then carefully moves the closure 200 to its open position, brings the rim 206 of the closure 200 to their lips, and pours the unmixed first and second flowable substances into their mouth as separate flows.

In the variation to the described embodiment in which the separator 143 is omitted and the closure 200 comprises a divider which, when the closure 200 is at the closed position, is disposed in the mixing chamber and isolates the first portion of the mixing chamber from the second portion of the mixing chamber and which, when the closure 200 is at the open position, places the first portion of the mixing chamber in fluid communication with the second portion of the mixing chamber, mixing of the first and second flowable substances in the whole container 1 is prevented until such time as the closure 200 is placed at its open position. The divider prevents mixing in the mixing chamber of the first and second flow able substances, even if the container is inverted, when the closure 200 is at the closed position, but permits such mixing in the mixing chamber when the closure 200 is at the open position. After providing the respective predetermined volumes of the first and second flowable substances in the first and second outlet zones 141, 142, the user places the closure 200 at its open position, to cause mixing of the respective predetermined volumes of the first and second flowable substances in the mixing chamber. The user then carefully brings the rim 146 of the third vessel 140 to their lips, and then pours the mixed predetermined volumes of the first and second flowable substances into their mouth.

While the invention has been described with respect to specific examples including presently preferred modes of carrying out the invention, those skilled in the art will appreciate that there are numerous variations and permutations of the above described systems and techniques. It is to be understood that other embodiments may be utilized and structural and functional modifications may be made without departing from the scope of the present invention. Thus, the scope of the invention should be construed broadly as set forth in the appended claims.

1. A multi-chamber container for dispensing flowable substances, comprising:
a body having:
a first storage chamber for storing a first flowable substance,
a second storage chamber for storing a second flowable substance,
a first outlet zone,
a second outlet zone,
a first inlet that fluidly connects the first storage chamber with the first outlet zone,
a second inlet that fluidly connects the second storage chamber with the second outlet zone,
a first apparatus configured, on operation thereof, to dispense from the first storage chamber via the first inlet into the first outlet zone a first predetermined volume of the first flowable substance,
a second apparatus configured, on operation thereof, to dispense from the second storage chamber via the second inlet into the second outlet zone a second predetermined volume of the second flowable substance, and
a lever connected to the first and second apparatuses and rotatable relative to the first and second apparatuses between a first position and a second position, wherein rotation of the lever from the first position to the second position causes operation of the first and second apparatuses;
wherein the body comprises a frame to which the lever is rotatably mounted, which frame is immovable relative to the first and second storage chambers; wherein the first and second outlet zones are defined by a vessel, and wherein rotation of the lever relative to the frame from the first position to the second position causes movement of the vessel relative to the frame; wherein the vessel is connected to the lever via a cam mechanism comprising a projection of one of the vessel and the lever and a track of the other of the vessel and the lever, wherein the projection is disposed in or on the track so that rotation of the lever relative to the frame causes the projection to follow the track.

2. The container of claim 1, wherein the lever comprises the track and the vessel comprises the projection.

3. The container of claim 2, wherein rotation of the lever relative to the frame from the first position to the second position causes linear movement of the vessel relative to the frame.

4. The container claim 3, wherein the frame at least partially surrounds the vessel.

5. The container of claim 4, wherein the frame includes one or more features that cooperate with one or more features of the vessel to guide the movement of the vessel relative to the frame.

6. The container of claim 4, wherein the first and second apparatuses comprise respective pumps, optionally wherein the first and second apparatuses comprise respective piston pumps.

7. The container of claim 3, wherein the first apparatus comprises a first piston movably disposed in a first cylinder and the second apparatus comprises a second piston movably disposed in a second cylinder.

8. The container of claim 7, wherein the first and second cylinders are immovable relative to the frame, and rotation of the lever from the first position to the second position causes the first and second pistons to move in the respective first and second cylinders.

9. The container of claim 8, wherein the first and second pistons are immovable relative to the vessel.

10. The container of claim 7, comprising a first dip tube extending from the first cylinder to the first storage chamber and a second dip tube extending from the second cylinder to the second storage chamber.

11. The container of claim 10, comprising a closure movable relative to the body between a closed position, at which the closure isolates the first and second outlet zones from an exterior of the container, and an open position, at which the first and second outlet zones are in fluid communication with the exterior of the container.

12. The container of claim 11 wherein, when the closure is at the closed position, the closure is spaced from the first and second inlets.

13. The container of claim 11 wherein, when the closure is at the open position, the closure is detached from the body.

14. The container of claim 11, wherein the closure has a first cavity, a second cavity, and a divider isolating the first cavity from the second cavity and, when the closure is at the closed position, the first cavity is in fluid communication with the first outlet zone and the second cavity is in fluid communication with the second outlet zone.

15. The container of claim 11, comprising a lock for locking the closure at the closed position.

16. The container of claim 1, wherein the first and second storage chambers are defined by respective non-unitary first and second vessels, and the first and second outlet zones are defined by a third vessel that is non-unitary with the first and second vessels and is connected to the first and second vessels.

17. The container of claim 16, wherein the body has an end face and the first and second vessels are disposed in parallel between the third vessel and the end face.

18. The container of claim 1, wherein the body comprises a separator that isolates the first outlet zone from the second outlet zone.

19. The container of claim 1, wherein the first outlet zone is a first portion of a mixing chamber of the body and the second outlet zone is a second portion of the mixing chamber.

20. The container of claim 19, wherein the closure has a divider and, when the closure is at the closed position, the divider is disposed in the mixing chamber and isolates the first portion of the mixing chamber from the second portion of the mixing chamber and, when the closure is at the open position, the first portion of the mixing chamber is in fluid communication with the second portion of the mixing chamber.

21. The container of claim 20 wherein, when the closure is at the open position, the mixing chamber is free of the divider.

22. The container of claim 1, wherein the first outlet zone has a first volume equal to or greater than the first predetermined volume, and the second outlet zone has a second volume equal to or greater than the second predetermined volume.

23. The container of claim 1, wherein the first predetermined volume is equal to the second predetermined volume.

24. The container of claim 1, wherein the lever has a first end portion rotatably mounted to a first portion of the frame and a second end portion rotatably mounted to a second portion of the frame, and wherein the first and second apparatuses are disposed between the first and second end portions of the lever.

25. The container of claim 1, wherein the container is elongate with a longitudinal axis, and wherein the lever is rotatable about an axis that is perpendicular to the longitudinal axis.

26. The container of claim 25, wherein the longitudinal axis extends between a first end of the container and a planar end face of the container.

27. The container of claim 1, wherein the first and second inlets comprise respective check valves that allow respective flows of the respective flowable substances in a direction from the respective first and second storage chambers towards the respective first and second outlet zones and that prevent flow of respective first and second flowable substances in the respective opposite directions.

28. The container of claim 1, wherein the cam mechanism is configured such that movement of the lever from a first position relative to the first and second apparatuses wherein a longitudinal axis of the container passes through the lever, to a second position in which the lever is located on one side of the body of the container, causes the vessel to undergo linear movement from a primary position to a secondary position and then back from the secondary position in a direction towards the primary position; or alternatively wherein the cam mechanism is configured such that movement of the lever from a first position in which the lever is located on one side of the body to a second position in which the lever is located on the opposite side of the body causes the vessel to undergo linear movement from a primary position to a secondary position and then back from the secondary position in a direction towards the primary position; or alternatively wherein the cam mechanism is configured such that movement of the lever from a first position in which the lever is located on one side of the body to a second position in which the lever is located on the other side of the body and then back from the second position to the first position causes the vessel to undergo linear movement from a primary position to a second position and then back from the secondary position in a direction towards the primary position.

29. The container of claim 1, wherein the track is substantially elliptical.

30. The container of claim 1, wherein the cam mechanism comprises first and second projections projecting radially outwards from opposing sides of the vessel, and wherein the first and second projections are disposed in respective first and second tracks in the lever.

31. A multi-chamber container for dispensing flowable substances, comprising:
a body having:
a first storage chamber for storing a first flowable substance,
a second storage chamber for storing a second flowable substance,
a first outlet zone,
a second outlet zone,
a first inlet that fluidly connects the first storage chamber with the first outlet zone,
a second inlet that fluidly connects the second storage chamber with the second outlet zone,
a first apparatus configured, on operation thereof, to dispense from the first storage chamber via the first inlet into the first outlet zone a first predetermined volume of the first flowable substance,
a second apparatus configured, on operation thereof, to dispense from the second storage chamber via the second inlet into the second outlet zone a second predetermined volume of the second flowable substance, and
a lever connected to the first and second apparatuses and rotatable relative to the first and second apparatuses between a first position and a second position, wherein rotation of the lever from the first position to the second position causes operation of the first and second apparatuses;
wherein the lever has a first end portion rotatably mounted to a first portion of the frame and a second end portion rotatably mounted to a second portion of the frame, and wherein the first and second apparatuses are disposed between the first and second end portions of the lever.
